(19) United States
(12) Patent Application Publication
(10) Pub. No.: US 2014/0153713 A1
(43) Pub. Date: Jun. 5, 2014

(54) ELECTRONIC DEVICE AND METHOD FOR PROVIDING CALL PROMPT

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: XIN-SHU WANG, Wuhan (CN); JIAN-HUNG HUNG, New Taipei (TW); MIN YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/034,577

(22) Filed: Sep. 24, 2013

(30) Foreign Application Priority Data
Dec. 4, 2012 (CN) 2012105104489

(51) Int. Cl. H04M 3/02

(52) U.S. Cl. CPC H04M 3/02
USPC 379/373.01

(57) ABSTRACT

A method for providing a call prompt to an electronic device includes presetting a plurality of response commands and an indication signal. The method determines whether one of a plurality of predetermined call events has been triggered. When one of the predetermined call events has been triggered, the method determines whether a specific program is running in the electronic device, the specific program representing a program that is outputting audio signals currently. When the specific program is running in the electronic device, an interrupt command is generated and executed to control the specific program for a predetermined time duration. Then the indication signal is outputted during the predetermined time duration.

### BACKGROUND

1. Technical Field

Embodiments of the present disclosure relate to communication technology, and particularly to an electronic device and a method for providing a call prompt to the electronic device.

2. Description of Related Art

Electronic devices can be used to play music, movies, and other things that output audio signals. However, when a user is listening to audio signals of the electronic device, the user may not notice someone calling or messaging the user. Therefore, an improved method for providing a call prompt using the electronic device is desired.

### BRIEF DESCRIPTION OF THE DRAWINGS

FIG. 1 is a block diagram of one embodiment of an electronic device including a call prompt system.

FIG. 2 is a flowchart of one embodiment of a method for providing a call prompt using the call prompt system of FIG. 1.

FIG. 3 is a flowchart of one embodiment of step S4 in FIG. 2.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

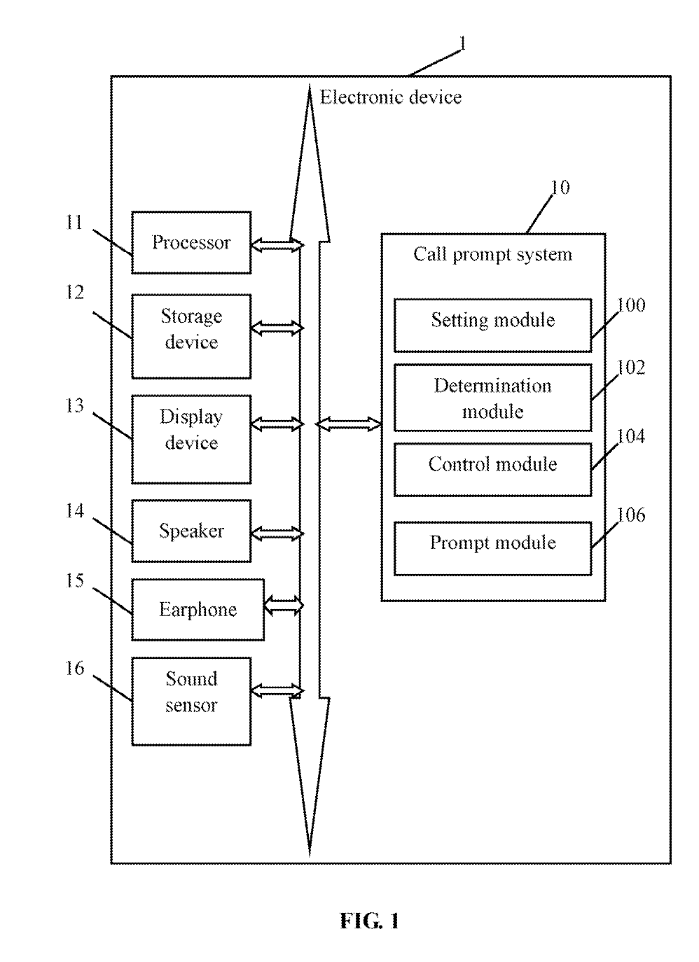

FIG. 1 is a block diagram of one embodiment of an electronic device 1 including a call prompt system 10. The electronic device 1 can be a communication device (e.g., a mobile phone), a tablet computer, a personal digital assistant, a notebook computer, or any other computing device. The electronic device 1 includes at least one processor 11, a storage device 12, a display device 13, a speaker 14, an earphone 15, and one or more sound sensors 16. In other embodiments, the electronic device 1 can include more or fewer components than illustrated, or have a different configuration of the various components.

The at least one processor 11 is used to execute the call prompt system 10 and other applications, such as an operating system, installed in the electronic device 1. The storage devices 12 store one or more programs, such as the operating system and applications of the electronic device 1. The storage device 12 can be a storage card, such as a memory stick, a smart media card, a compact flash card, a secure digital card, or any other type of memory storage device.

The display device 13 displays visible data, such as videos, images, or the like. The speaker 14 outputs audio signals, such as music, for example. The sound sensors 16 detect audio signals, such as ambient sounds, user speaking, for example.

The call prompt system 10 detects whether any predetermined call event has been triggered, and interrupts a program that is outputting audio signals when a predetermined call event has been triggered and outputs a predetermined indication signal to prompt a user of the electronic device that the predetermined call event is occurring. For example, the predetermined call event can include, but are not limited to, an event representing that a predetermined audio signal is received from the sound sensor 16, and an event representing that the electronic device 1 receives a phone call or a message.

The call prompt system 10 may include computerized instructions in the form of one or more programs that are executed by the at least one processor 11 and stored in one or more of the storage devices 12. In one embodiment, the call prompt system 10 includes one or more modules, for example, a setting module 100, a determination module 102, a control module 104, and a prompt module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

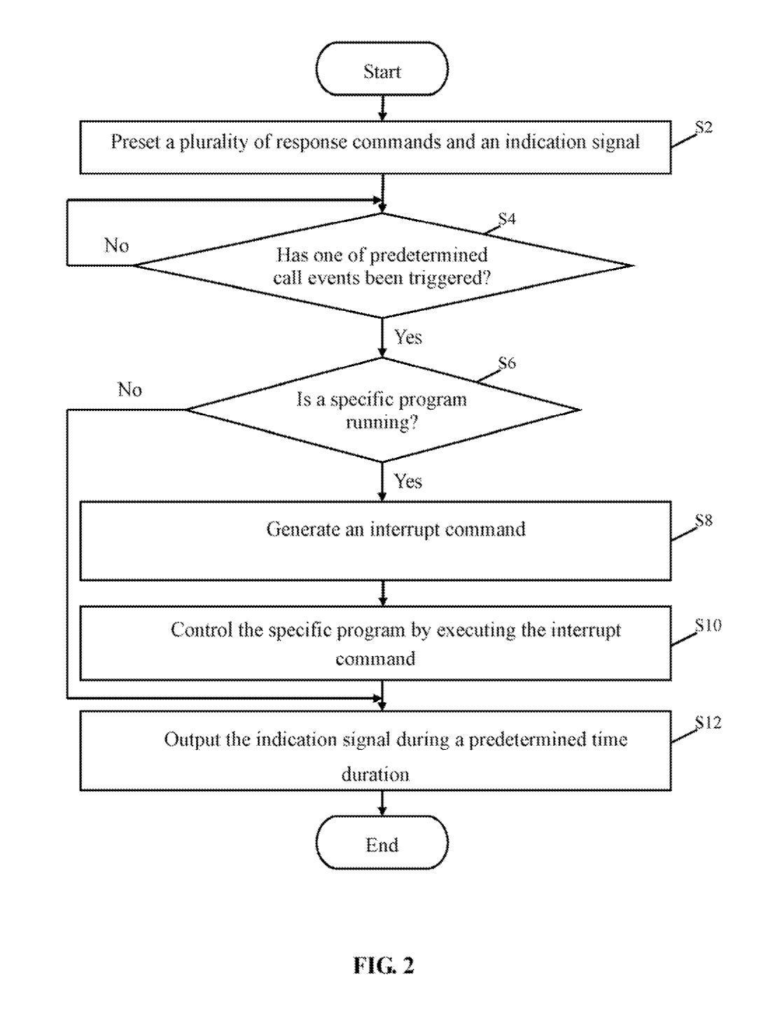

FIG. 2 is a flowchart of one embodiment of a method for providing a call prompt using the call prompt system 10. Depending on the embodiment, additional steps may be added, others removed, and the ordering of the steps may be changed.

In step S2, the setting module 100 presets a plurality of response commands and an indication signal. The response commands are used to determine whether someone is calling the user of the electronic device 1, and the indication signal is used to prompt the user when one of the response commands is detected. The response commands can be sounds recorded by the user using the sound sensor 16 and a recorder of the electronic device 1, or be text inputted from a keyboard of the electronic device 1. The response commands may be “Hank” or “Daddy,” for example.

In some embodiments, the indication signal may be an audio signal, such as “Hank, someone is calling you,” “Hank, please pick up the phone,” or “Hank, see your message,” for example. In other embodiments, the indication signal is a video or information that is displayed on the display device 13. Detailed descriptions are provided as follows.

The response commands and the indication signal can be modified, newly added, or deleted by the user using the setting module 100.

In step S4, the determination module 102 determines whether one of the predetermined call events has been triggered. In some embodiments, the predetermined call events are preset by the user using the setting module 100, and include, but are not limited to an event representing that a detected audio signal received from the sound sensor 16 is the same as one of the response commands, an event representing that the electronic device 1 has received a message (e.g., a Short Message Service (SMS) message or a Multimedia Messaging Service (MMS) message), and an event representing that the electronic device 1 has received a phone call.

For example, when another person nearby the user calls the name of the user when the user is listening to music, the sound sensor 16 detects the audio signal, and then transmits the detected audio signal to the determination module 102. The determination module 102 compares the detected audio signal with the response commands. The determination module 102 may recognize the detected audio signal using a known speech recognition technology.

When the detected audio signal (e.g., “Hank”) received from the sound sensor 16 is the same as one of the response commands, or when the electronic device 1 has received a message or a phone call, the determination module 102 determines that one of the predetermined call events has been triggered, and step S6 is implemented. When no predetermined call event has been triggered, step S4 is repeated.

In step S6, the determination module 102 determines whether a specific program is running in the electronic device 1. In some embodiments, the specific program represents a program that is outputting audio signals. The specific program may be a music player, a video player, for example. When there is a specific program running in the electronic device 1, step S8 is implemented. When no specific program is running in the electronic device 1, step S12 is implemented.

In step S8, the control module 104 generates an interrupt command, which is used to control the specific program.

In step S10, the control module 104 controls the specific program by executing the interrupt command For example, the interrupt command controls the program to mute the audio signals for a predetermined time duration (e.g., 1 minute), or pauses the program for the predetermined time duration.

In other embodiments, the interrupt command closes the running program. After the predetermined time duration elapses, the control module 104 restarts the program after the predetermined time duration elapses. Furthermore, the control module 104 records running parameters of the specific program before executing the interrupt command to close the specific program, and times the predetermined time duration. After the predetermined time duration elapses, the control module 104 restarts the specific program according to the running parameters.

In step S12, the prompt module 106 outputs the indication signal during the predetermined time duration. The prompt module 106 outputs the indication signal using the speaker 14, the earphone 15, or using the display device 13. For example, when one of the predetermined call events has been triggered when a music player is running, the control module 104 pauses the music player for the predetermined time duration, and the prompt module 106 outputs the indication signal using the speaker 14 or the earphone 15.

In some embodiments, after the predetermined time duration elapses, the control module 104 restores the specific program. For example, the control module 104 allows the specific program to continue to output the audio signals, or to run in the electronic device 1, after the predetermined time duration elapses. For another example, the control module 104 allows to restart the specific program after the predetermined time duration elapses, according to the running parameters recorded before closing the specific program.

In other embodiments, after the predetermined time duration elapses, the determination module 102 further determines whether the sound sensor 16 detects any audio signal. For example, if a triggered call event is a telephone call and the user continues talking into the sound sensor 16 after the predetermined time duration, the control module 104 detects the audio signals from the user speaking into the sound sensor 16, and the control module 104 executes the interrupt command again until the sound sensor 16 detects no audio signals. When the sound sensor 16 detects no audio signal, the control module 106 restores the specific program as mentioned above.

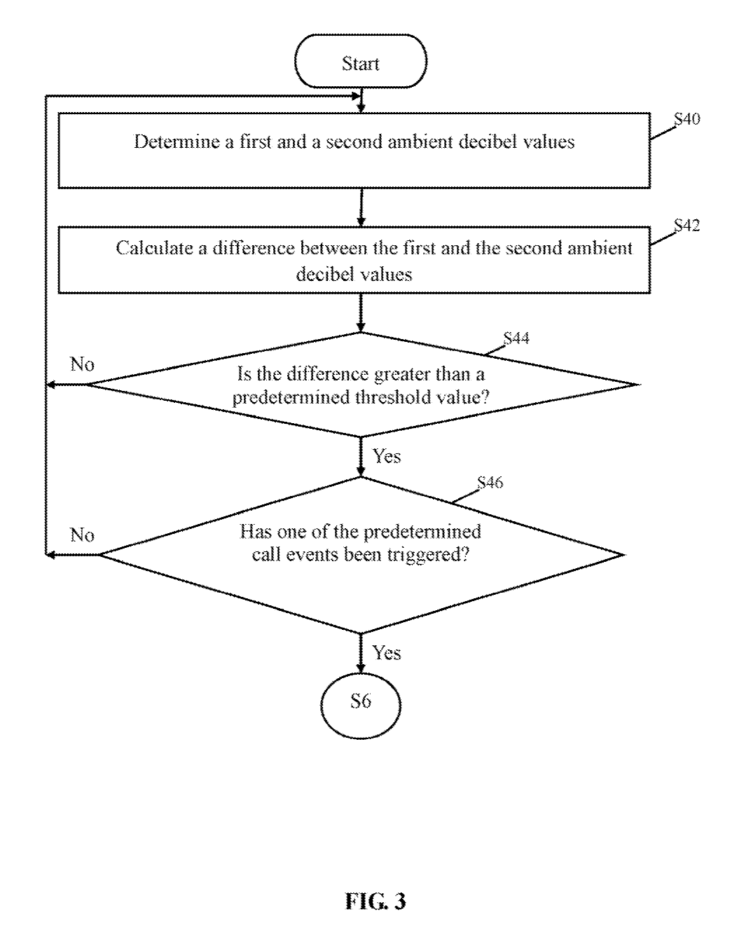

In other embodiments, the determination module 102 further executes sub steps S40 to S46 in FIG. 3, when the electronic device 1 is connected to the earphone 15.

FIG. 3 is a flowchart of one embodiment of step S4 in FIG. 3. Depending on the embodiment, additional steps may be added, others removed, and the ordering of the steps may be changed.

In step S40, the determination module 102 determines a first ambient decibel value and a second ambient decibel value. The second ambient decibel value of the electronic device 1 corresponds to the detected audio signals received from the sound sensor 16 as mentioned in step S4. The first ambient decibel value corresponds to an anterior audio signal detected by the sound sensor 16, the anterior audio signal is acquired before the detected audio signal, that is, the anterior audio signal and the detected audio signal are consecutive audio signals.

In step S42, the determination module 102 calculates a difference between the first ambient decibel value and the second ambient decibel value.

In step S44, the determination module 102 determines whether the difference is greater than a predetermined threshold value. The predetermined threshold value is preset by the setting module 100. If the difference is greater than the predetermined threshold value, step S46 is executed. If the difference is less than or equal to the predetermined threshold value, the anterior audio signal and the detected audio signal are ignored, the procedure returns to step S40.

In step S46, the determination module 102 determines whether one of the predetermined call events has been triggered. If one of the predetermined call events has been triggered, the procedure goes to step S6 as mentioned in FIG. 2. If no predetermined call event has been triggered, the procedure returns to step S40.

It should be noted that, in other embodiments, steps S40 to S44 can be removed.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for providing a call prompt using an electronic device, the electronic device comprising a sound sensor and a speaker, the method comprising:
presetting a plurality of response commands, and presetting an indication signal;
determining whether one of predetermined call events has been triggered, the predetermined call events comprising an event representing that a detected audio signal received from the sound sensor is the same as one of the plurality of response commands;
determining whether a specific program is running in the electronic device when one of the predetermined call events has been triggered, the specific program representing a program that is outputting audio signals currently;
generating an interrupt command when the specific program is running in the electronic device;
executing the interrupt command to control the specific program, comprising: controlling the specific program to mute the audio signals for a predetermined time duration; and
outputting the indication signal during the predetermined time duration.

2. The method according to claim 1, wherein the predetermined call events further comprise an event representing that the electronic device has received a message, and an event representing that the electronic device has received a phone call.

3. The method according to claim 1, wherein the electronic device is connected to an earphone, and before the step of determining whether one of predetermined call events has been triggered, the method further comprises:
determining a first ambient decibel value of the electronic device according to an anterior audio signal acquired before the detected audio signal, and determining a second ambient decibel value of the electronic device according to the detected audio signals received from the sound sensor;
calculating a difference between the first ambient decibel value and the second ambient decibel value;
determining whether the difference is greater than a predetermined threshold value; and
executing the step of determining whether one of predetermined call events has been triggered, when the difference is greater than a predetermined threshold value; or
ignoring the audio signals received from the sound sensor and not executing the step of determining whether one of predetermined call events has been triggered, when the difference is less than or equal to a predetermined threshold value.

4. The method according to claim 1, further comprising:
restoring the specific program after the predetermined time duration elapses.

5. The method according to claim 1, wherein the step of executing the interrupt command to control the specific program further comprises:
recording running parameters of the specific program;
exiting the specific program, and timing the predetermined time duration; and
restarting the specific program according to the running parameters after the predetermined time duration elapses.

6. The method according to claim 1, further comprising:
determining whether the sound sensor detects any audio signal after the predetermined time duration elapses;
executing the interrupt command again, when the sound sensor detects one or more audio signal after the predetermined time duration elapses; or
restoring the specific program when the sound sensor detects no audio signal after the predetermined time duration elapses.

7. An electronic device comprising:
at least one processor; and
a plurality of storage devices storing files and a plurality of instructions, which when executed by the processor, causes the at least one processor to:
preset a plurality of response commands, and presetting an indication signal;
determine whether one of predetermined call events has been triggered, the predetermined call events comprising an event representing that a detected audio signal received from the sound sensor is the same as one of the plurality of response commands;
determine whether a specific program is running in the electronic device when one of the predetermined call events has been triggered, the specific program representing a program that is outputting audio signals currently;
generate an interrupt command when the specific program is running in the electronic device;
execute the interrupt command to control the specific program, comprising: control the specific program to mute the audio signals for a predetermined time duration; and
output the indication signal during the predetermined time duration.

8. The electronic device according to claim 7, wherein the predetermined call events further comprise an event representing that the electronic device has received a message, and an event representing that the electronic device has received a phone call.

9. The electronic device according to claim 7, wherein the electronic device is connected to an earphone, and before determining whether one of predetermined call events has been triggered, the at least one processor further:
determines a first ambient decibel value of the electronic device according to an anterior audio signal acquired before the detected audio signal, and determines a second ambient decibel value of the electronic device according to the detected audio signals received from the sound sensor;
calculates a difference between the first ambient decibel value and the second ambient decibel value;
determines whether the difference is greater than a predetermined threshold value; and
determines whether one of predetermined call events has been triggered, when the difference is greater than a predetermined threshold value; or
ignores the audio signals received from the sound sensor, when the difference is less than or equal to a predetermined threshold value.

10. The electronic device according to claim 7, wherein the at least one processor further:
restores the specific program after the predetermined time duration elapses.

11. The electronic device according to claim 7, wherein the at least one processor further:
records running parameters of the specific program;
exits the specific program, and times the predetermined time duration; and
restarts the specific program according to the running parameters after the predetermined time duration elapses.

12. The electronic device according to claim 7, wherein the at least one processor further:
determines whether the sound sensor detects any audio signal after the predetermined time duration elapses;
executes the interrupt command again, when the sound sensor detects one or more audio signal after the predetermined time duration elapses; or
restores the specific program when the sound sensor detects no audio signal after the predetermined time duration elapses.

13. A non-transitory storage medium having stored thereon instructions that, when executed by a processor of an electronic device, causes the electronic device to perform a method for providing a call prompt, the method comprising:
presetting a plurality of response commands, and presetting an indication signal;
determining whether one of predetermined call events has been triggered, the predetermined call events comprising an event representing that a detected audio signal received from the sound sensor is the same as one of the plurality of response commands;
determining whether a specific program is running in the electronic device when one of the predetermined call events has been triggered, the specific program representing a program that is outputting audio signals currently;
generating an interrupt command when the specific program is running in the electronic device;
executing the interrupt command to control the specific program, comprising: controlling the specific program to mute the audio signals for a predetermined time duration; and
outputting the indication signal during the predetermined time duration.

14. The non-transitory storage medium according to claim 13, wherein the predetermined call events further comprise an event representing that the electronic device has received a message, and an event representing that the electronic device has received a phone call.

15. The non-transitory storage medium according to claim 13, wherein the electronic device is connected to an earphone, and before the step of determining whether one of predetermined call events has been triggered, the method further comprises:
determining a first ambient decibel value of the electronic device according to an anterior audio signal acquired before the detected audio signal, and determining a second ambient decibel value of the electronic device according to the detected audio signals received from the sound sensor;
calculating a difference between the first ambient decibel value and the second ambient decibel value;
determining whether the difference is greater than a predetermined threshold value; and
executing the step of determining whether one of predetermined call events has been triggered, when the difference is greater than a predetermined threshold value; or
ignoring the audio signals received from the sound sensor and not executing the step of determining whether one of predetermined call events has been triggered, when the difference is less than or equal to a predetermined threshold value.

16. The non-transitory storage medium according to claim 13, wherein the method further comprises:
restoring the specific program after the predetermined time duration elapses.

17. The non-transitory storage medium according to claim 13, wherein the step of executing the interrupt command to control the specific program further comprises:
recording running parameters of the specific program;
exiting the specific program, and timing the predetermined time duration; and
restarting the specific program according to the running parameters after the predetermined time duration elapses.

18. The non-transitory storage medium according to claim 13, wherein the method further comprises:
determining whether the sound sensor detects any audio signal after the predetermined time duration elapses;
executing the interrupt command again, when the sound sensor detects one or more audio signal after the predetermined time duration elapses; or
restoring the specific program when the sound sensor detects no audio signal after the predetermined time duration elapses.
